(19) United States
(12) Patent Application Publication
(10) Pub. No.: US 2022/0245976 A1
(43) Pub. Date: Aug. 4, 2022

(54) SecureConnex

(71) Applicant: James Daniel Luciano, New Hope, PA (US)

(72) Inventor: James Daniel Luciano, New Hope, PA (US)

(21) Appl. No.: 17/649,487

(22) Filed: Jan. 31, 2022

Related U.S. Application Data
(60) Provisional application No. 63/144,229, filed on Feb. 1, 2021.

(51) Int. Cl. G07C 5/08; G07C 5/00; G06F 16/27

(52) U.S. Cl. CPC G07C 5/0841; G06F 16/27; G07C 5/0808; G07C 5/008

(57) ABSTRACT

Vehicular data is blockchain recorded for immutable storage. Any vehicle (e.g., a car, truck, bus, marine, construction) may generate the telemetry data, the diagnostic data (e.g., OBDII), maintenance data, and the vehicular data. The blocks of data and/or the blockchain may be locally generated by the vehicle and recorded to the blockchain by a hardware processor (such as an engine controller, a chassis controller, or other electronic control module). Additionally or alternatively, the telemetry data, the diagnostic data, maintenance data, and the vehicular data may be wirelessly transmitted from the vehicle (via a network interface to a communications network) for routing to a network destination (such as a server or blockchain peer node) that records the corresponding data to blocks of data within the blockchain. The telemetry data, the diagnostic data, maintenance data, and any other vehicular data is timestamped and immutably recorded for analysis, for verification, and for marketing/sales opportunities.

### CROSS-REFERENCE TO RELATED APPLICATION

This patent application claims domestic benefit of U.S. Provisional Application No. 63/144,229 filed Feb. 1, 2021 and incorporated herein by reference in its entirety.

### BACKGROUND

Massive amounts of electronic data are generated. Our cars, appliances, computers, and other devices generate electronic data describing sensor outputs, states, location, content, messaging, and signals. All this electronic data, though, is usually lost, ignored, and/or susceptible to alteration.

### BRIEF DESCRIPTION OF THE SEVERAL VIEWS OF THE DRAWINGS

These and other features, aspects, and advantages of exemplary embodiments are better understood when the following Detailed Description is read with reference to the accompanying drawing, wherein:

FIG. 1 is a flowchart illustrating a method or algorithm for writing OBD data, according to exemplary embodiments.

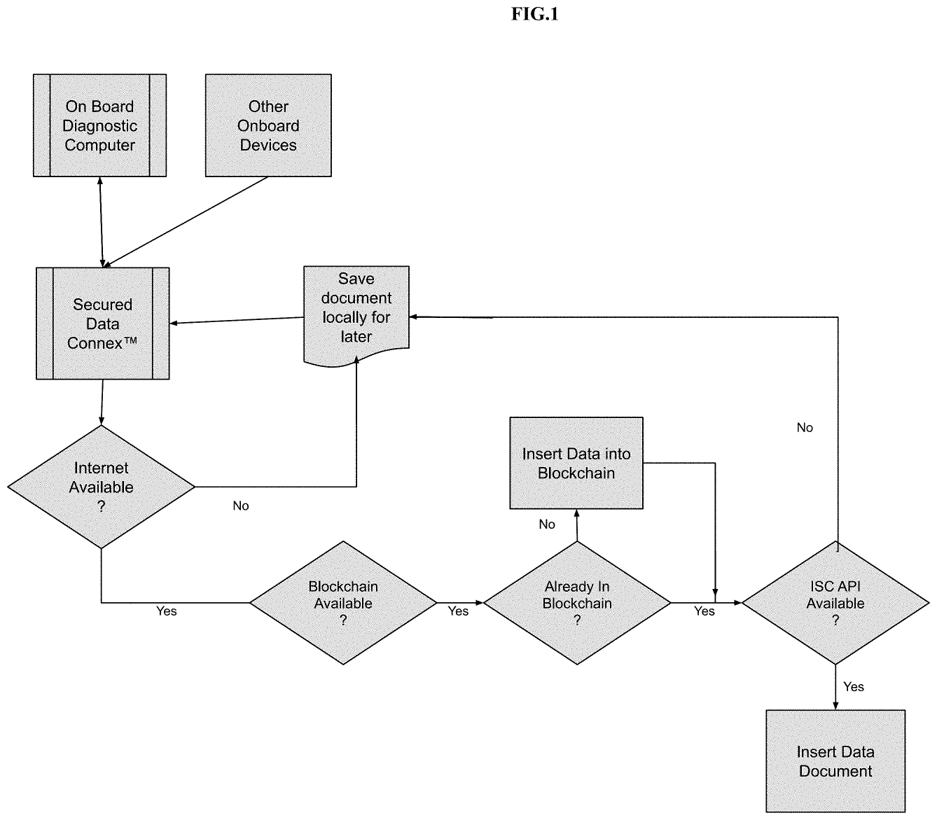

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

The accompanying drawings illustrate blockchain recordation of telemetry data, diagnostic data, maintenance data, and any other vehicular data for immutable storage. That is, a car, truck, bus, construction vehicle, or any other vehicle may generate the telemetry data, the diagnostic data (e.g., OBDII), maintenance data, and the vehicular data. The blocks of data and/or the blockchain may be locally generated by the vehicle and recorded to the blockchain by a hardware processor (such as an engine controller, a chassis controller, or other electronic control module). Additionally or alternatively, the telemetry data, the diagnostic data, maintenance data, and the vehicular data may be wirelessly transmitted from the vehicle (via a network interface to a communications network) for routing to a network destination (such as a server or blockchain peer node) that records the corresponding data to blocks of data within the blockchain. The telemetry data, the diagnostic data, maintenance data, and any other vehicular data is timestamped and immutably recorded for analysis, for verification, and for marketing/sales opportunities.

Blockchain recordation may be referenced to mileage and/or a vehicle identification number. Because the vehicle identification number may be unique to the vehicle, the telemetry data, the diagnostic data, and the other vehicular data may be recorded and referenced to the vehicle identification number. Any of the data recorded in the blocks of data in the blockchain may thus be sorted, filtered, and found based on the mileage and/or the VIN. Queries may thus be issued for the mileage and/or the VIN and the corresponding blocks of data in the blockchain may be identified, retrieved, and analyzed according to the mileage and/or the VIN. As an example, each oil change, tire rotation, brake pad replacement, filter replacement, and other maintenance may be immutably recorded to the blockchain, along with the mileage and the VIN. Any accident repair and/or component replacement may be immutably recorded to the blockchain, along with the mileage and the VIN. Indeed, daily or routine use may be immutably recorded to the blockchain, including date, time, vehicular speed, GPS location, and any sensory signal outputs.

Blockchain recordation identifies candidates for automated certified pre-owned status. Because the blockchain immutably records maintenance and use, the data recorded in the blocks of data in the blockchain may be identified, retrieved, and analyzed for data traits. For example, vehicles that record timely and correct maintenance (according to a manufacturer's service schedule) are likely candidates for automated certified pre-owned status. A manufacturer or dealer, in other words, may search/filter the entries in the blockchain to identify those vehicles that have been well maintained, lightly used, and never wrecked. A server may thus be programmed to search the blockchain and identify the vehicles that are best suited for the certified pre-owned status. Those vehicles having blockchain data records that do not satisfy/match desired query parameters may be disqualified for the certified pre-owned status.

The blockchain(s) may be associated with the manufacturer. Toyota, for example, may program its vehicles to report their VIN, mileage, telemetry data, diagnostic data, and other vehicular data to the blockchain dedicated to Toyota. A proprietary blockchain identifier (or Chain ID) may thus be used to reference the correct blockchain for Toyota's vehicles. Similarly, Honda may also have its own blockchain(s) that is/are dedicated to vehicles manufactured by Honda. Each vehicle or OEM may thus implement manufacturer-specific blockchains to record manufacturer-specific data. Tier 2, Tier 3, and other component suppliers may also implement their own specific blockchains to record data generated by their components. Any manufacturer, supplier, or service provider may thus implement a proprietary blockchain identifier (or Chain ID) to record and reference supplier-specific blockchains.

Access to any blockchain may be restricted. Toyota, for example, may establish policies, permissions, and other procedures for accessing Toyota-specific blockchains. Any third-party wishing to access the blocks of data must satisfy the policies or possess the correct permissions. Component suppliers (such as Delphi, Magna, and Rockwell) may similarly establish their respective policies, permissions, and procedures for accessing supplier-specific blockchains. Any third party has access to what they need and not more than what they need. Toyota thus determines what device/server/user access Toyota's blockchain (or “data lake”). Toyota, for example, may own all the information. So, when Toyota vehicle leases a vehicle, and after the lease ends, the vehicle is then sold off-lease as a used, pre-owned vehicle. A buyer of the off-lease as a used, pre-owned vehicle is an independent owner.

The owner may then decide to continue blockchain recordation. Even though ownership has transferred, the vehicle is still collecting and recording data to the blockchain (e.g., the VIN, mileage, telemetry data, diagnostic data, and other vehicular data). The owner may continue authorizing Toyota to collect the blockchain data, or the new owner may decide to utilize a different party or service to collect the blockchain data. As an example, suppose State Farm or other insurance provider offers reduced premiums or discounts based on sharing the blockchain data. State Farm may thus have permission access to the vehicle's blockchain data records and, based on driving and maintenance records (as revealed by inspection of the vehicle's blockchain data records), State Farm may rate or access risk and accordingly price auto insurance. So, even though the vehicle has come off-lease and been sold to a new owner, Toyota may still acquire the vehicle's blockchain data records and share with other service providers.

The blockchain may also be searched. The vehicle's blockchain data records may record/log the owner/driver, VIN, manufacturer, make/model, mileage, location, and any other sensor data. The vehicle's blockchain data records may be sent via a communications network to a server for storage in an electronic database. The database entries may thus map, relate, or associate the vehicle's blockchain data records to the owner/driver, VIN, manufacturer, make/model, mileage, location, and any sensor data (such as oxygen or O² sensor, OBDII data, GPS location, odometer). The server may thus receive a query from a client device that specifies a query or search parameter. The server operates as a query handler and searches the electronic database for the query or search parameter and identifies or retrieves the corresponding database entries. The server may thus send a query response that specifies or identifies the corresponding database entries. As a simple example, suppose State Farm asks Toyota to identify all the Lexus vehicles located in Austin, Tex. that report low mileage (e.g., such as a maximum odometer of 20,000 miles) and proper maintenance (e.g., minimum number of oil changes). That is, State Farm's computer infrastructure (such as a server) sends a query to the server (perhaps operated on behalf of Toyota), and the query specifies the query or search parameters (such as location=Pennsylvania, odometer<20,000, and oil changes>3). Toyota's server may thus query the electronic database and identify the corresponding database entries that satisfy the query or search parameters. Moreover, the search results may be anonymous, in that the server may decline to identify and retrieve the corresponding VIN, owner, home address, and other personally identifying information. Toyota may thus aggregate and share any blockchain data records, but the blockchain data records may be selectively revealed to maintain privacy. Of course, State Farm may incur an added fee (such as a cryptographic coinage transfer) for revealing the VIN, owner, home address, and other personally identifying information. State Farm may then solicit those owners whose blockchain data records satisfy the specific query or search parameters.

The data lake may also be accessed by other vendors and service providers. Jiffy Lube and other maintenance providers may have permission access to the blockchain data records. Home painters, plumbers, and electricians may pay or subscribe for access to the blockchain data records. Even automotive dealers may pay or subscribe for access to the blockchain data records. Whatever the vendor or service provider, the service provider may query Toyota's server for the specific query or search parameters representing their desired or targeted clientele. Each one of these vendors then has a financial relationship for crypto-paid access. A service technician need not physically access the vehicle, plug in and interface to the OBDII system, and read/download the codes and other diagnostic data. The vehicular data, instead, is recorded to the blockchain. Any entity may pay or subscribe for access to the blockchain data records.

Any permissive scheme may be used to access the blockchain data records. One or more application programming interfaces, for example, may be establish for access to the blockchain data records. Client devices may access a webpage login system to a secure website. Moreover, a virtual private network with a secured structure for the protocol to access the blockchain data records. Permissions may be established using cryptographic identities.

Vehicle buyers also benefit. Dealers and individuals may pay for access to the blockchain data records. An owner of the vehicle, for example, need not maintain maintenance records. Instead, the owner may merely rely on the blockchain for immutable storage. A potential buyer of the vehicle may also access the blockchain for historical maintenance records. Indeed, potential buyers may search for vehicles matching their preferred query search parameters. The blockchain data records provide certification that the vehicle has been correctly described and properly maintained. The blockchain data records are real-time proof of mileage, diagnostics, and maintenance. Buyers may thus search and locate candidate vehicles by maintenance entry, by location, by mileage, and by another other search query. Manufacturers and financial lenders/lessors may even list vehicles off-lease or soon to become available.

Moreover, potential buyers may be found. The blockchain data records may be searched to find potential buyers of vehicles. Again, before the vehicle lease expires, the lessor or lessee may search the blockchain data records for specific parameters describing those mostly likely to buy the vehicle off-lease. The blockchain data records may be searched for particular school districts, address locations, demographics, income distribution, and/or recent or past vehicle purchases. The blockchain data records may searched to reveal neighborhoods that are most likely to buy vehicles of this type. Moreover, a selling price may be predicted, perhaps based on mileage, maintenance records, driving habits, and other information revealed by the blockchain data records. So, given the vehicle type, given the vehicle information, one could search and discover buyers. Purchase offers could be targeted to potential buyers, based on the real-time or near real-time blockchain data records.

Service is improved. Whenever the vehicle is serviced, the service provider may enter service codes and other maintenance/service records to the vehicle's ECM or other controller. The vehicle may itself write those service records, or the vehicle may upload the service record via an RF/cellular/satellite/WiFi/Bluetooth network connection.

The telemetry data, the diagnostic data (e.g., OBDII), maintenance data, and the vehicular data may be cryptographically proved. Any sensor generates an output signal (e.g., voltage/current) in response to an input condition (e.g., pressure, temperature, mechanical position, weight, speed, voltage, current, on/off). A controller receives the output signal (perhaps via a vehicular CAN bus) and compares the output signal to an acceptable range of values or max/min limits. If the output signal lies within the acceptable range of values or below/above the max/min limits, then perhaps the controller is programmed to infer or determine a normal operation. However, if the output signal lies outside the acceptable range of values or beyond the max/min limits, then perhaps the controller is programmed to infer abnormal operation. The controller may generate and report a diagnostic error (such as an OBDII error code). The controller may further generate a cryptographic proof of the diagnostic error by hashing a bit value representing the diagnostic error. The cryptographic proof may be written to the blockchain and/or wirelessly reported to a blockchain peer node operating in a blockchain network. The cryptographic proof documents the generation of the diagnostic error. Once the diagnostic error is resolved (perhaps by a software update and/or by a service procedure), another cryptographic proof may be generated and blockchain recorded to document resolution.

Exemplary embodiments may use any encryption or hashing function. There are many encryption algorithms and schemes, and exemplary embodiments may be adapted to execute or to conform to any encryption algorithm and/or scheme. In the blockchain environment, though, many readers may be familiar with the various hashing algorithms, especially the well-known SHA-256 hashing algorithm. The SHA-256 hashing algorithm acts on any electronic data or information to generate a 256-bit hash value as a cryptographic key. The key is thus a unique digital signature. However, there are many different hashing algorithms, and exemplary embodiments may be adapted to execute or to conform to any hashing algorithm, hashing family, and/or hashing scheme (e.g., Blake family, MD family, RIPE family, SHA family, CRC family).

Exemplary embodiments improve computer functioning. Because exemplary embodiments may telemetry data, the diagnostic data (e.g., OBDII), maintenance data, and the vehicular data to the blockchain, controllers may utilize slower and cheaper processors and memory devices. Memory bytes, in other words, need not be consumed by long term storage of OBDII data. The vehicular data need only be uploaded, via a communications network, to the blockchain network. Cache and other memory devices may then be cleared/overwritten, perhaps according to a reporting time interval that matches a block time of the blockchain network. Suppose, for example, that the blockchain generates a new block of data every ten (10) minutes. An engine control unit (ECU), therefore, need only have a small memory byte size capable of storing about ten (10) minutes of diagnostic data (e.g., OBDII), maintenance data, and the vehicular data. After a predefined time (say about 9 minutes), and/or when the memory storage is about capacity, the ECU may instruct a wireless interface to upload the collected/caches data from the vehicle to the blockchain network. Once the upload write is complete or verified, the ECU may clear the allocated memory and begin storing new data. Smaller/Less memory devices may be used, and the hardware processor may have slower processor cycles. Frequent blockchain writes also reduces electrical power consumption by the ECU and by a vehicle alternator, which also reduces gasoline/fuel consumption.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for blockchain recordation of any electronic data, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method executed by a server that records a vehicular diagnostic data, the method comprising:
receiving, by the server, the vehicular diagnostic data reported via a communications network by a vehicle;
reading, by the server, a vehicle identification number (VIN) specified by the vehicular diagnostic data;
querying, by the server, an electronic database for the VIN specified by the vehicular diagnostic data, the electronic database having entries that map different vehicle identification numbers to different blockchains;
identifying, by the server, an entry of the entries in the electronic database that maps the VIN of the different vehicle identification numbers to a blockchain of the different blockchains;
writing, by the server, the vehicular diagnostic data a block of data associated with the blockchain mapped by the entry to the VIN; and
publishing, by the server, the vehicular diagnostic data written to the block of data associated with the blockchain mapped by the entry to the VIN.

2. A server that records a vehicular diagnostic data, comprising:
a hardware processor; and
a memory device storing instructions that when executed by the hardware processor perform operations, the operations comprising:
receiving on-board diagnostic data (OBD) reported via a communications network from a vehicle;
reading a vehicle identification number (VIN) specified by the OBD;
querying an electronic database for the VIN specified by the OBD, the electronic database having entries that map different VINs to different blockchains;
identifying an entry of the entries in the electronic database that maps the VIN to a blockchain of the different blockchains;
writing the OBD to a block of data associated with the blockchain mapped by the entry to the VIN; and
publishing the OBD written to the block of data associated with the blockchain mapped by the entry to the VIN.

3. A memory device storing instructions that when executed by a hardware processor perform operations, the operations comprising:
receiving an on-board diagnostic data (OBD) reported via a communications network from a vehicle;
reading a vehicle identification number (VIN) specified by the OBD;
querying an electronic database for the VIN specified by the OBD, the electronic database having entries that map different VINs to different blockchains;
identifying an entry of the entries in the electronic database that maps the VIN to a blockchain of the different blockchains;
writing the OBD to a block of data associated with the blockchain mapped by the entry to the VIN; and
publishing the OBD written to the block of data associated with the blockchain mapped by the entry to the VIN.
